(19) United States
(12) Patent Application Publication
(10) Pub. No.: US 2004/0039707 A9
(43) Pub. Date: Feb. 26, 2004

(54) Method for distributing and licensing digital media

(76) Inventor: Chris Ricci, Cookstown (CA)

Correspondence Address: LERNER AND GREENBERG, P.A., POST OFFICE BOX 2480, HOLLYWOOD, FL, 33022-2480, US

(21) Appl. No.: 10/017,636

(22) Filed: Nov. 21, 2001

Related U.S. Application Data
(60) Provisional application No. 60/252,334, filed on Nov. 22, 2000.

(51) Int. Cl. G06F 17/60; H04K 1/00; H04L 9/00

(52) U.S. Cl. 705/59

(57) ABSTRACT

A method shares digital media across a network of peers. The method licenses the digital media. The method provides advertisements relating to the recipient's interests, demographics, and downloaded media. By displaying advertisements, the recipient are charged for licensing the digital media.

### CROSS-REFERENCE TO RELATED APPLICATION

This application claims the benefit of U.S. Provisional Application No. 60/252,334, filed Nov. 22, 2000.

### BACKGROUND OF THE INVENTION

1. Field of the Invention

The invention relates to a method for distributing digital media such as MP3 files across a network and, in particular, for licensing the digital media being transferred.

2. Description of the Related Art

Traditional business models for distributing media such as music and video include direct sales to consumers. Even when media is broadcast for “free”, it usually includes the hidden cost of advertising in the form of commercials, traditional ad banners, or pop up images.

The digitization of media and promulgation of computer networks ha s revolutionized prior business models. Users realized the potential of sharing data from user to user to avoid distributors and commercials. In turn, this promulgation has unexpected results on copiers, distributors, and copyright holders. The history of these effects is related below.

Computers store information digitally. Perhaps the greatest advantage of this, is that exact copies can be made. However, this means that digitally stored copyrighted material could be duplicated without significant efforts and without degradation.

For most copyright holders the threat of copying was not extensive because the originals as well as the copies were so large in the case of compact discs and video that the number of copies that any computer could hold was very limited and the time required for transfer was too great. However, the volume of data being shared exploded as digitally recorded media data became smaller as methods for algorithmically compressing and decompressing data were developed. Algorithmic compression methods were developed to shrink the size of digital audio and video files. Some of the best known of these algorithms include the Moving Picture Experts Group (MPEG) and in particular the MPEG audio layer 3, better known as MP3. Other popular compression formats include MPG, “DivX”, and “DeCSS” (DVD Video).

Despite the presence of growing amounts of compressed digital data, users were initially unable to distribute their data or receive data from others because they were not able to find where it was stored in an immense network like the Internet. If a webserver were to distribute unlicensed copyrighted compressed digital data, the copyright owner was able to legally enjoin the transfer because the number of such servers was limited and their identities were readily obtainable. So, at least initially, copyright holders such as music authors and record companies were not loosing sales. However, the writing was on the wall.

As the amount of data exploded, so did the need for tool to locate, filter, and transfer data while not exposing a user's own data to unacceptable risks. The most commonly used solution to this need is known as Peer to Peer (P2P) networking, or file sharing networks, these technologies allow individual computer users to form online communities by sharing their own data on their computer with other connected members of the community. The greatest advantage was that data could be transferred directly from user to another (i.e. peers) without transferring that data from a server as was traditional in most web databases. Initially, peer to peer networks such as NAPSTER®, reduced the amount of copyrighted music being sold through legitimate channels. Record companies were unable to locate and stop the multitude of infringers transferring unlicensed copyrighted material across peer-to-peer networks. However, that all stopped when the recording industry successfully enjoined peer to peer networks such as NAPSTER that were facilitating the transfer of almost entirely unlicensed copyrighted material.

Previous peer-to-peer network users desired to continue to share digital media but lacked avenues to obtain licensed copyrighted material.

In addition, traditional peer-to-peer networks do not determine and track file transfers. In fact, most pure P2P networks by their illicit nature, intentionally do not help owners track their multi-media intellectual rights.

In light of the previous historical background, a more thorough description of P2P networks is provided below:

1. A user logs onto a server on a network.

2. The user shares selected digital media to others on the network.

3. The user then queries the other computers on the network if a desired digital media file exits on the network.

4. Every computer on the network responds with a YES or a NO depending on whether they have the file.

5. The user then selects a computer having the digital media and transfers the data from the computer

6. Simultaneously, other users can query the user's computer and transfer data from the user's computer.

### SUMMARY OF THE INVENTION

It is accordingly an object of the invention to provide a method for distributing and licensing digital media that overcomes the above-mentioned disadvantages of the heretofore-known devices and methods of this general type and that harnesses the desire and popularity of peer-to-peer networks without relinquishing control of the distribution from the copyright owners.

With the foregoing and other objects in view there is provided, in accordance with the invention, a method for sharing digital media across a network. The first step of the method is forming a request including recipient information and digital media information. The next step is requesting digital media by transmitting the request from a recipient to a server. The next step is selecting in the server the digital media corresponding to the request. The next step is transmitting the digital media to the recipient corresponding to the request. The next step is recording in the server the recipient information and the digital media.

In accordance with a further object of the invention, the method insures that even an anonymous user downloading a file will pay the owner the appropriate royalty.

In accordance with a further object of the invention, the method displays advertisements targeted at the media being distributed. The transferring, decoding, or playing of the digital media could activate or initialize the server to display an advertisement. The advertisement can be audio files, videos, or images.

In accordance with a further object of the invention, the method tracks what digital media users are sharing.

In accordance with a further object of the invention, the method checks the digital media being shared for integrity and uniformity throughout the network. The digital media would be verified after transfer by the recipient. An easy way to confirm a copy is to verify that the file size of the copy is identical to the original. By verifying uniformity and integrity, a recipient is guaranteed to be licensing perfect copies. In addition, verifying uniformity and integrity prevents incomplete or nonconforming copies from being promulgated across the network.

In accordance with a further object of the invention, the method tracks the digital media being downloaded.

In accordance with a further object of the invention, the method calculates the copyright royalty payment owed to the copyright owner/licensor.

In accordance with a further object of the invention, the method shares all digital media files including but not limited to MP3, MP2, WINDOWS MEDIA® Audio format (WMA), REAL® audio files, e-books, AVI, APPLE® QUICKTIME® MOV files, and WINDOWS® ASF.

In accordance with a further object of the invention, the method generates top-ten, top-fifty, and top-one-hundred lists on the network and other top lists published by outside sources and allows users to download licensed copies of those songs.

In accordance with a further object of the invention, the method reduces the costs for copyright owners to distribute files by reducing the amount of file space taken by files by allowing an original from a server once it has been promulgated across the network. The method also reduces the bandwidth required by the distributor to distribute the files because once the song has been promulgated to peers, transfers of the digital media can be made on the bandwidth of the peers rather than the originator.

In accordance with a further object of the invention, the method provides a peer-to-peer network that cannot be enjoined by copyright owners because it transfers licensed digital media. In an alternate embodiment, all media (licensed and unlicensed media) can be transferred by paying a royalty. The royalty may be a traditional charge or be in the form of receiving advertisements. If an owner of an unlicensed copyright work seeks royalties from the server, royalties can be provided from a pool created by advertisements on unlicensed transfers.

In accordance with a further object of the invention, the method collects royalties without charging subscription fees.

In accordance with a further object of the invention, the method promotes peer-to-peer networking in general by legally distributing licensed digital media. The invention also can collect royalties for unlicensed digital media that can be disbursed to owners.

In accordance with a further object of the invention, the method tracks adult and pornographic or explicit content digital media and prevents its distribution to users who are minors.

In accordance with a further object of the invention, the method delivers media of one type (e.g. audio) with advertisements in the same or another medium (e.g. video, graphics, or text). This feature increases the possibilities of delivering high impact, targeted advertisements that enhance the media being downloaded. For example, a song by an artist could be downloaded. This song could be linked to an advertisement containing a picture of that artist endorsing a product.

In accordance with a further object of the invention, the method targets an advertisement that is relevant to the user. To correlate advertisements to the user, the user can provide demographic information. Preferably, when a new user signs on, the new user can be asked demographic information. Other relevant information can be recorded as well such as the user's location or the language that the user speaks. In addition, users can list their interests, such as types of music or movies, or favorite artists. In addition, the file sharing histories can be used to profile the user for targeting advertisements. In addition, a history of which advertisements have been sent to a user can be maintained to prevent repetitive advertising. Then advertisements are delivered to the user. Preferably, the advertisements are targeted at the user based on their demographics, interests and history. Advertisements can be displayed, for example, during download, throughout playing, or at the initiation of playing. Preferably, the advertisement is an audio advertisement. In addition, the user can choose an advertisement from several possibilities.

Some of these problems with digital information protection systems may be overcome with the following method. The first step is adding recipient information to the digital media to produce a resulting file that is unique for the digital media and the recipient. This file can be encrypted so only the recipient can access the digital media with the added information. The digital media can be encrypted to allow only the recipient to decode and play the digital media. The encryption should be hardware neutral; that is, no special hardware is required to decrypt the encrypted digital media. The method can transfer the encrypted digital media. Encrypted digital media can be copied easily for back-up purposes and transferred easily for distribution. However, if the digital media is moved to a different computer as identified by its IP address, hostname, or other identifier, the digital media may have to be relicensed and a new key might have to be issued. The decrypted digital media cannot be copied. In particular, the encrypted digital media is stored as an executable computer program, which includes a decryption program that decrypts the encrypted information to provide the desired digital information, upon successful completion of an authorization procedure by the user. The decryption can be a daemonic system that initiates verification of a license and could initiate advertisements being displayed. The encrypted file can be given a proprietary file extension such as FMF for “Free Media Format”. If an unlicensed user attempts to decrypt or transfer the encrypted digital media, the server is contacted, and the unlicensed user is asked to register and license the media; this license can be in the form of advertisements being displayed.

In accordance with a further object of the invention, the method enforces payment of royalties and controls access to decryption keys and prevents playing of digital media unless a license is purchased; the license can be charged by displaying advertisements. The present invention provides an improved method for identifying and detecting sources of unauthorized copies. Copies that do not comply with the original (for example, by having different file size or an altered title) can be excluded.

In accordance with a further object of the invention, the method limits the number of times that the digital information can be transferred. In addition, licenses allowing addition copies can be purchased.

In accordance with a further object of the invention, the method a server is contacted only when contents are being used. During transfer of the digital media, the network would act like a typical peer-to-peer network without requiring a central server.

In addition to the foregoing, following features and advantages are provided in accordance with aspects of this invention:

Data modularity: a recipient's (i.e., an end user's) applications (i.e., media player) can retrieve and interpret parts of structure as they arrive, i.e., digital media can be streamed to the recipient.

Other features which are considered as characteristic for the invention are set forth in the appended claims.

Although the invention is illustrated and described herein as embodied in method for distributing and licensing digital media, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic drawing showing a network and the communication between the interconnected peers and server; and

FIG. 2 is a flowchart showing a method of sharing and licensing files across the network.

### DESCRIPTION OF THE PREFERRED EMBODIMENTS

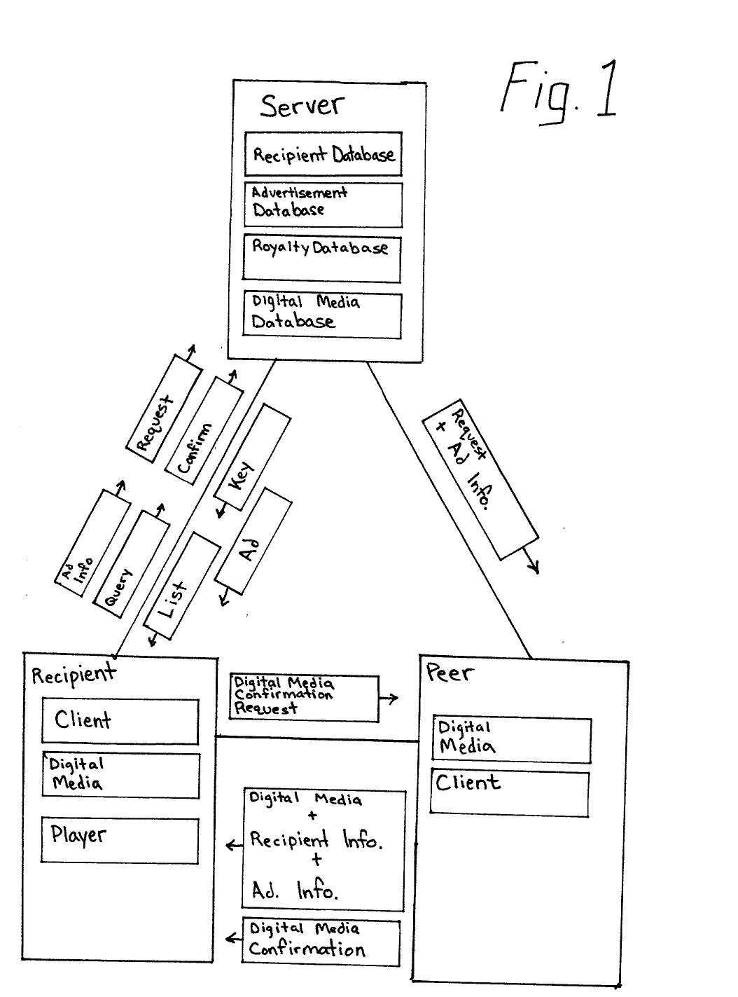

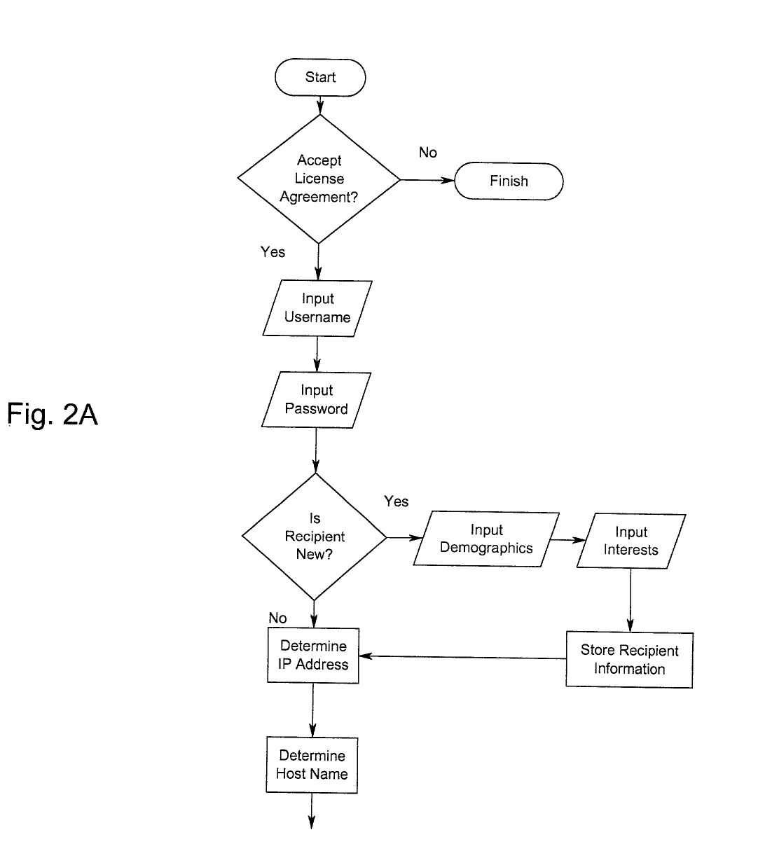

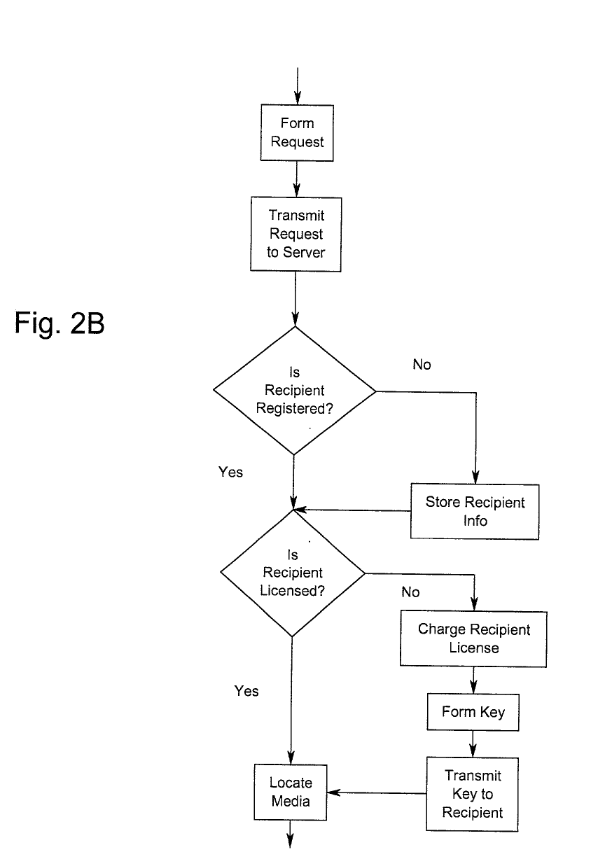

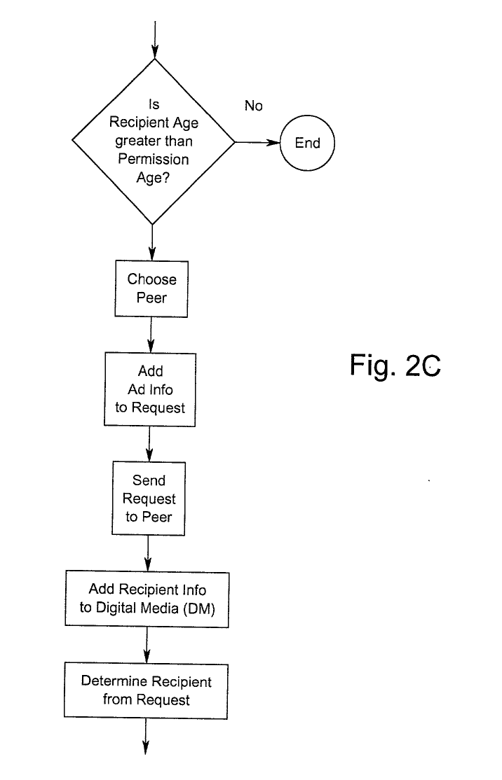

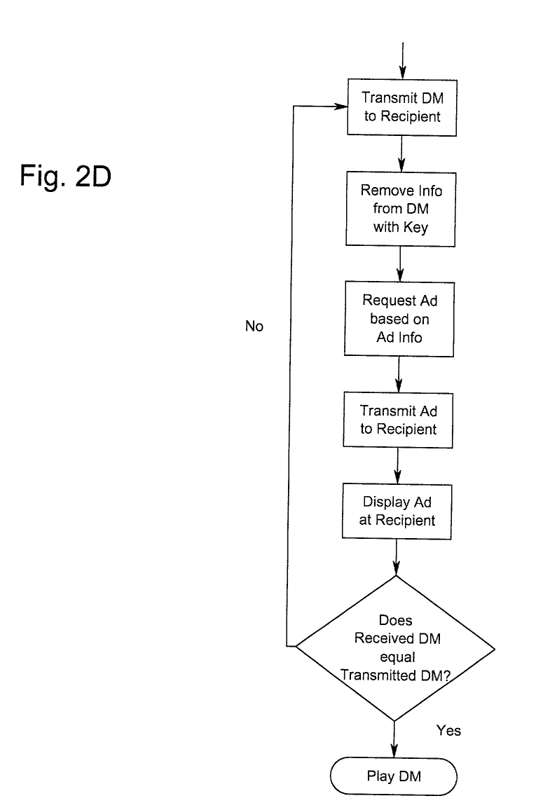

Referring now to the figures of the drawing in detail and first, particularly, to FIG. 1 thereof, there is seen a network of computers including a server and two peers. While all of the peers have the same functionality, for purposes of illustrating the method of the invention, one of the peers will be referred to as the recipient.

A server in the network connects to each peer. The server contains several databases and generally controls, facilitates, and monitors the transfer of digital media among peers on the network.

One such database in the server is a digital media database that indexes all of the digital media stored on the server and the peers of the network. The digital media database includes the identity of the peer storing the data and information about the digital media such as author, title, file type, length, etc.

The next server database is an advertisement database. The advertisement database contains advertisements that are observable in the peers. The term observable is used because advertisements that are images and video can be seen, and audio can be heard. The advertisement database also relates the advertisements to demographics and digital media. For example, many musicians (especially touring musicians) are sponsored by manufacturers (such as soft drink and beer manufactures). The advertisement database also can show advertisements for stores to recipients located in areas where the stores are located. Another example is that products for teenagers can be shown to only recipients having a certain age. So, advertisements for sponsors can be displayed when a sponsored artist's digital media is played. The advertisement database also includes data bout how many times each recipient has seen each advertisement.

Another database in the server is a recipient database. The recipient database stores recipient information. To maximize recipients' privacy, the data stored in the server can be limited to as little as the username and password. At the same item, other pertinent data can be kept in the respective clients and used as necessary.

The server also can include a royalty database. The royalty database includes the costs of licensing the digital media, the limits of the license (i.e., duration, number of uses) and relates the royalties to the recipients database to track which recipients have licensed which digital media.

The network can be any computer network including, but not limited to, LANs, WANs, and wireless networks. Preferably, the network utilizes the TCP/IP protocol. Most preferably, the network is the Internet.

Each peer (i.e., the recipient) is a computer on the network running the client, which is a program. Each peer includes digital media that can be shared. To play the media, each peer will usually have a media player.

The recipient begins by executing the client software. At least once, the client asks the recipient to accept a license agreement. The license agreement can include terms such as the limits and duration of the license. If the recipient does not agree to the license, the client terminates.

In the next steps, the recipient enters their username and password. The server confirms these by comparing them with the recipient database. If the recipient is new, or if the username does not exist or password is incorrect, the registrant is asked to enter a new username and password. When new usernames are entered, recipients are prompted to enter demographic information and information about their interests. The demographic information should include the recipient's age. The server then records in the recipient database the necessary recipient information.

After registering, a recipient search for digital media. Typically, a query includes at least part of the name of a work or artist. The server then searches its digital media database based on the query. The server then sends to the recipient a list of available digital media. Each piece of digital media could include a permissible age. Typically, the permissible age is set by third parties, such as the publisher, artists, or other groups. If the age of the recipient is less than the permissible age, the recipient is blocked from transferring the digital media. Recipients can also choose to block digital media that has no rating. The recipient then requests a particular piece of digital media on a particular peer for transfer from the results. Each piece of digital media on the network has unique digital media information.

Next, additional recipient information is gathered to uniquely identify the recipient. This recipient information can include an IP address of the recipient. IP addresses are useful because they uniquely identify a user's identity and location on the Internet. However, using an IP address of a recipient to verify their identity can be problematic if they have a dynamically assigned IP address. Because dynamically assigned IP addresses change at each logon, any key depending on that IP address also will expire. Therefore, instead of an IP address the recipient information can include more static information such as the hostname of the peer computer. A third possibility is to utilize both the hostname and the IP address of the peer computer.

Next, the client forms a request. The request includes the digital media information and the recipient information. The request is transmitted via the network to the server.

The server then reads the request. The server compares the recipient information contained in the request to the recipient database and verifies that the recipient is registered.

The server then verifies that the recipient is licensed to receive the digital media. If the recipient is licensed, then the digital media can be transferred as described below. If the digital media is not licensed, the recipient is charged a royalty, most preferably in the form of an advertisement, which is recorded in the royalty database of the server.

Next, the server forms a key. The key includes the recipient information and the digital media information. In this way, each key is unique for each piece of digital media and user. The key is then transmitted to the recipient according to the recipient information.

To transmit the digital media to the recipient, the server begins by adding ad information to the request. Ad information is short information that identifies which advertisement in the server's advertisement network should be played by the recipient. The advertisement information (and therefore advertisement) can be selected by matching the recipient's demographics, interests, and download database, and languages spoken to provide advertisements that would have the greatest impact on the recipient.

The request including the advertisement information is then forwarded to the peer holding the original digital media. The peer selects the digital media to be forwarded based on the digital media information in the request. Next, recipient information is added to the digital media. In addition, the advertisement information is added to the digital media. The client running in the peer is responsible for adding the information. Preferably, the client in the peer will add the information to the digital media and encode it by using traditional algorithms. When encoding, the digital media and other information can form a new file. Preferably, the new file is executable and can be identified by its own file-name extension. The digital media being sent to the recipient is unique based on the recipient and the digital media. Preferably, the digital media with the information is not playable.

The digital media is then sent to the recipient according to the recipient information. The client on the recipient uses the key to remove the information from the digital media by using the key. As the client removes the information from the digital media, the client sends the ad information to the server. In turn, the server downloads a related advertisement to the recipient. The client then displays the advertisement to the recipient. The advertisement can be set to display at various times. For example, the advertisement can play as the digital media is being received by the recipient. The advertisement could be displayed the first time that the digital media is played. The advertisement could also be set to play every time that the digital media is opened.

Preferably, when an advertisement is displayed, the client on the recipient sends a confirmation to the server. This allows the server to track how often advertisements have been played. The server can change the advertisements being sent to prevent repeats. The advertisement can also be removed after the initial displaying of the advertisement. Alternatively, the advertisement can be set to play a predetermined number of times then remove itself. Once removed, the digital media could be played a predetermined or unlimited times on the same recipient's computer. The digital media can also be set to expire according to other factors such as time.

Before playing the digital media for at least the first time, the client verifies that the digital media is identical to the original that was being transferred. The recipient client can do this by sending a digital media confirmation request to the client running on the peer. The digital media confirmation includes information such as the file size. The peer client confirms that the digital media are identical and then sends a digital media confirmation to the recipient client. If the digital media are not identical, the recipient can repeat the transfer.

I claim:

1. A method for sharing digital media across a network, which comprises:
forming a request including recipient information and digital media information;
requesting digital media by transmitting the request from a recipient to a server;
selecting in the server the digital media corresponding to the request;
transmitting the digital media to the recipient corresponding to the request; and
recording in the server the recipient information and the digital media information.

2. The method according to claim 1, which includes charging a license to the recipient for the digital media.

3. The method according to claim 1, which includes verifying that the recipient has licensed the digital media before transferring the digital media.

4. The method according to claim 3, which includes charging the recipient a license for the digital media when the recipient does not have a license for the media.

5. The method according to claim 1, which includes:
storing the digital media on a peer connected to the network;
sending the request from the server to the peer; and
transmitting the digital media from the peer to the recipient based on the recipient information.

6. The method according to claim 1, which includes tracking with the server which digital media are being shared on each peer.

7. The method according to claim 1, which includes confirming that the digital media received by the recipient is identical to the digital media having been sent.

8. The method according to claim 1, which includes selecting the digital media from the group consisting of MP2, MP3, MPG, MOV, WMA, WAV, JPG, GIF, DOC, RTF, PDF, e-books, APPLE® QUICKTIME® movies, DivX, DVD, and BMP.

9. The method according to claim 1, which includes generating a list of most transferred digital media per unit time.

10. The method according to claim 1, which includes generating a list of most commonly occurring digital media.

11. The method according to claim 1, which includes storing the digital media on the server.

12. The method according to claim 1, which includes not charging a subscription fee.

13. The method according to claim 1, which includes:
adding a recipient's age to the recipient information;
listing a permissible age for the digital media; and
blocking transfers of the digital media when the recipient's age is below the permissible age.

14. The method according to claim 1, which includes adding an IP address of the recipient to the recipient information.

15. The method according to claim 1, which includes adding a host name of the recipient to the recipient information.

16. The method according to claim 1, which includes:
adding data to the digital media before transferring the digital media; and
removing the data from the digital media after transferring the digital media.

17. The method according to claim 16, which includes adding the recipient information to the data.

18. The method according to claim 17, which includes:
sending from the server to the recipient a key; and
requiring the key to play the digital media.

19. The method according to claim 18, which includes forming the key to be unique to the digital media and the recipient information.

20. The method according to claim 16, which includes making the digital media unplayable while the data is added.

21. The method according to claim 18, which includes adding advertisement information to the data.

22. The method according to claim 21, which includes displaying an advertisement based on the advertisement information.

23. The method according to claim 22, which includes relating the advertisement to the recipient information.

24. The method according to claim 22, which includes relating the advertisement to the digital media.

25. The method according to claim 22, which includes transferring the advertisement from the server to the recipient.

26. The method according to claim 22, which includes notifying the server when the advertisement has been played.

27. The method according to claim 22, which includes:
adding a language spoken by the recipient to the recipient information; and
tailoring the advertisement to the language.

28. The method according to claim 16, which includes making the digital media into an executable file.

29. The method according to claim 21, which includes displaying the advertisement before playing the digital media.

30. The method according to claim 29, which includes displaying the advertisement each time the digital media is played.

31. The method according to claim 29, which includes changing the advertisement each time the digital media is played.

32. The method according to claim 18, which includes removing the data from the digital media with the key.

33. The method according to claim 18, which includes requiring the key every time the digital media is played.

34. The method according to claim 18, which includes expiring the key after a period of time.

35. The method according to claim 29, which includes displaying the advertisement while the digital media is transferring.
